(19) United States
(12) Patent Application Publication
(10) Pub. No.: US 2015/0034359 A1
(43) Pub. Date: Feb. 5, 2015

(54) ELECTRIC INSULATION CABLE WITH SHIELD

(71) Applicant: HITACHI METALS, LTD., Tokyo (JP)

(72) Inventors: Keisuke SUGITA, Hitachi-shi (JP); Akinari NAKAYAMA, Tokyo (JP)

(73) Assignee: HITACHI METALS, LTD., Tokyo (JP)

(21) Appl. No.: 14/269,651

(22) Filed: May 5, 2014

(30) Foreign Application Priority Data
Jul. 30, 2013 (JP) 2013-158040
Oct. 16, 2013 (JP) 2013-215397

(51) Int. Cl. H01B 7/295; H01B 3/44

(52) U.S. Cl. CPC H01B 7/295; H01B 3/441
USPC 174/107

(57) ABSTRACT

There is provided an electric insulation cable with shield, including: conductors; an insulating layer provided on an outer periphery of the conductors; a braided shield provided on an outer periphery of the insulating layer; and a sheath provided on an outer periphery of the braided shield, wherein the sheath is made of a silane-crosslinked composition which is obtained by silane-crosslinking a non-halogen composition under a normal pressure, and the non-halogen composition includes 100 pts.mass of silane-grafted polymer obtained by graft copolymerizing a silane compound to the polymer including at least one of non-halogen rubber and ethylene-based copolymer, and includes 1 pts.mass or more and 10 pts.mass or less of an antioxidant.

### BACKGROUND

1. Technical Field

The present application is based on Japanese Patent Application No. 2013-158040 filed on Jul. 30, 2013, the entire contents of which are hereby incorporated by reference.

The present invention relates to an electric insulation cable with shield.

2. Description of Related Art

The electric insulation cable with shield is used in wiring in a carriage as a power cable of a hybrid vehicle and an electric vehicle.

In order to prevent a mixture of a noise into electronic equipment disposed in a vehicle, a shield is provided in the electric insulation cable with shield (simply called an electric insulation cable hereafter). Specifically, the electric insulation cable includes conductors, an insulating layer coating an outer periphery of the conductors, a shield coating an outer periphery of the insulating layer, and a sheath coating an outer periphery of the shield, sequentially from a center to outside. A braided shield in which metal wire is weaved, is used as the shield, so as not to damage flexibility required for the electric insulation cable.

Various characteristics such as heat resistance, flame retardancy, and mechanical characteristic, etc., are required for the sheath and the insulating layer, and therefore a specific polymer is used. The insulating layer is formed by coating the outer periphery of the conductors by extruding the polymer, and the sheath is formed by extrusion-coating the polymer on the outer periphery of the braided shield. The polymer includes rubber or resin, and halogen-based rubber such as chloroprene rubber, etc., and non-halogen rubber such as ethylenpropylne rubber, etc., are used as rubber, and non-halogen crystalline resin such as polyethylene, etc., having relatively low crystallinity, for example, are used as resin. Above all, the non-halogen rubber or non-halogen crystalline resin, etc., has been used, because harmful halogen-based gas is not generated in case of incineration or fire.

Crosslink processing is applied to the insulation layer or sheath for improving heat-resistance, and the polymer constituting the sheath, etc., is crosslinked. A crosslinking method by organic peroxide and electron beam irradiation can be given as the crosslink processing.

When the polymer is crosslinked by organic peroxide, the polymer is crosslinked by heating it by adding the organic peroxide. Specifically, the polymer including the organic peroxide is used for extrusion-coating applied to the sheath or insulating layer, and the sheath and the insulating layer are exposed to a steam environment of high temperature and high pressure.

Under such a high temperature and high pressure environment, the organic peroxide is decomposed to generate a free radical (RO.). Due to a progress of a crosslinking reaction by such a free radical, the polymer constituting the sheath and the insulating layer, is crosslinked.

However, the polymer thus used for the extrusion-coating of the sheath, involves a problem of biting into meshes of the braided shield and strongly adhering thereto by a high pressure added during the crosslinking reaction. Similarly, the polymer thus used for the extrusion-coating of the insulating layer, also involves a problem of strongly adhering to the conductor or the braided shield. If the sheath or the insulating layer is strongly adhered to the braided shield, the sheath is hardly peeled-off when terminal processing is applied to the electric insulation cable, or the braided shield is hardly folded, to thereby reduce a terminal processing performance.

Therefore, in the crosslink processing by the organic peroxide, a separator is provided for suppressing an adhesion of the sheath or the insulating layer (for example, see patent document 1). Specifically, as shown in FIG. 3, an inner layer separator 150a is provided between conductors 110 and an insulating layer 120, and a middle separator 150b is provided between the insulating layer 120 and a braided shield 130, and an outer layer separator 150c is provided between the braided shield 130 and a sheath 140, respectively, in the electric insulation cable 100. The separator 150 (150a to 150c) is formed by winding a polyethylene terephthalate tape, etc., for example, and the adhesion to the braided shield 130, etc., of the sheath 140 is thereby suppressed. Thus, the adhesion of the insulating layer 120 and the sheath 140 to the braided shield 130 can be reduced, and the terminal processing performance of the electric insulation cable 100 can be improved.

When the polymer is crosslinked by electron beam irradiation, the polymer is crosslinked by irradiating the polymer with electron beams. Specifically, extrusion-coating of polymer is performed to the sheath and the insulating layer, and thereafter the sheath and the insulating layer are irradiated with electron beams. In this case, ionization, excitation, and dissociation of a bond of the polymer occurs by electron beams, and a radical is generated. Due to the progress of the crosslinking reaction by such a radical, the polymer constituting the sheath and the insulating layer, is crosslinked. When the polymer is crosslinked by electron beam irradiation, the high pressure environment is not required like the organic peroxide, and therefore the sheath and the insulating layer can be formed not through the separator.

Thus, when the polymer is crosslinked by the organic peroxide or by the electron beam irradiation, the crosslinking reaction is advanced by generating the radical.

Incidentally, it is known that the sheath and the insulating layer made of polymer are oxidized and deteriorated by light and heat. For example, when the sheath is exposed to the light and heat, in the polymer constituting the sheath, alkyl radical (R.) is generated, and oxidation/deterioration of the sheath is advanced. Further, various radicals are generated by the reaction between the generated alkyl radical and the polymer, thus increasing the radicals in a chain reaction, to thereby accelerate the oxidation/deterioration of the sheath. By advancement of the oxidation/deterioration of the sheath with an elapse of time, various characteristics of the sheath are gradually reduced. In order to suppress the reduction of the various characteristics due to the oxidation/deterioration, an antioxidant is included in the sheath (for example see patent document 2). By this antioxidant, the radical is captured and decomposed, to thereby suppress the chain generation of the radicals, and suppress the advancement of the oxidation/deterioration of the sheath. By including the antioxidant, the sheath is excellent in thermal stability by suppressing the oxidation/deterioration caused by heat.
Patent document 1
Japanese Patent Laid Open Publication No. 2000-232933
Patent document 2
Japanese Patent Laid Open Publication No. 2007-207642

However, the antioxidant included in the sheath involves a problem that it is consumed when crosslinking the sheath by the organic peroxide or the electron beam irradiation. As described above, the crosslinking reaction by the organic peroxide and the electron beam irradiation, is advanced by generating the radicals, similarly to the oxidation/deterioration by heat. Therefore, the antioxidant included in the sheath is consumed by capture and decomposition of the radicals generated during the crosslinking reaction of the polymer. As a result, content of the antioxidant is reduced in the crosslinked sheath, and therefore the thermal stability is likely to be low.

In order to obtain a specific thermal stability, increase of the content of the antioxidant can be considered, in consideration of a consumed amount of the antioxidant during the crosslinking reaction. However, generally the antioxidant has a low molecular weight, and therefore there is a problem that as the content of the antioxidant is increased, flame retardancy of the sheath is reduced. In order to compensate the reduction of the flame retardancy, the content of a flame retardant agent can be increased. However, in this case, another problem is generated, such that mechanical characteristics and flexibility of the sheath are reduced. Thus, when crosslinking is applied to the sheath by the organic peroxide or the electron beam irradiation, it is difficult to achieve both the thermal stability and flame retardancy of the sheath.

In addition, when crosslinking is applied to the sheath by the organic peroxide, a plurality of separators are required to be used for the electric insulation cable. Therefore, there is a problem that the flexibility of the electric insulation cable is reduced, and the terminal processing performance is insufficient because a part of the separators is remained when processing is applied to the terminal of the electric insulation cable.

Further, when crosslinking is applied to the sheath by electron beam irradiation, the reduction of the flexibility of the electric insulation cable is suppressed because the separators are not required, but if the crosslinked sheath is thick, the electron beams are hardly transmitted into the sheath, thereby involving a problem that the sheath cannot be uniformly crosslinked in a thickness direction. Therefore, in a thick sheath, degree of the crosslink in the thickness direction is different, and there is a problem that variation of various characteristics easily occurs.

Therefore, an object of the present invention is to provide the electric insulation cable with shield having excellent thermal stability, flame retardancy, and flexibility.

### SUMMARY OF THE INVENTION

According to an aspect of the present invention, there is provided an electric insulation cable with shield, including:

conductors;

an insulating layer provided on an outer periphery of the conductors;

a braided shield provided on an outer periphery of the insulating layer; and

a sheath provided on an outer periphery of the braided shield,

wherein the sheath is made of a silane-crosslinked composition which is obtained by silane-crosslinking a non-halogen composition under a normal pressure, and the non-halogen composition includes 100 pts.mass of silane-grafted polymer obtained by graft copolymerizing a silane compound to the polymer including at least one of non-halogen rubber and ethylene-based copolymer, and includes 1 pts.mass or more and 10 pts.mass or less of an antioxidant.

### BRIEF DESCRIPTION OF THE DRAWINGS

FIG. 1 is a cross-sectional view of an electric insulation cable with shield according to an embodiment of the present invention.

FIG. 2 is a cross-sectional view of the electric insulation cable with shield according to a second embodiment of the present invention.

FIG. 3 is a cross-sectional view of a conventional electric insulation cable with shield.

### DETAILED DESCRIPTION OF THE INVENTION

### 1. Knowledge of Inventors of the Present Invention

Knowledge obtained by inventors of the present invention will be described, before the explanation of an embodiment of the present invention.

As described above, when the crosslinking is applied to the sheath by organic peroxide or electron beam irradiation, following problems are generated.

(1) In the crosslink by organic peroxide or electron beam irradiation, a crosslinking reaction is advanced by generation of radicals, and therefore an antioxidant is consumed during the crosslinking reaction.
(2) In the crosslink by the organic peroxide, a plurality of separators are required to be provided for an electric insulation cable with shield, for causing a reaction under a high temperature and high pressure environment.
(3) In the crosslink by the electron beam irradiation, uniform crosslink is not achieved, uniformly in a thickness direction of a sheath.

From above problems (1) to (3), it can be considered that the crosslinking reaction is not a radical reaction and the crosslinking reaction under the high temperature and high pressure is not required, and these points are important. The inventors of the present invention examine the crosslinking method of the sheath, and as a result, it is found that silane-crosslink is appropriate.

According to the silane-crosslink, the crosslinking reaction is not the radical reaction, and therefore consumption of the antioxidant can be prevented during the crosslinking reaction. Namely, content of the antioxidant is not required to be increased in consideration of a consumed amount, and the content can be decreased. Thus, in the sheath, thermal stability is achieved and reduction of flame retardancy by including the antioxidant, can be suppressed. Further, since the reduction of the flame retardancy can be suppressed, the content of a flame retardant agent is not required to be increased (content can be reduced), and reduction of mechanical characteristics and flexibility of the insulating layer and the sheath due to the content of the flame retardant agent, can be suppressed.

Further, since the crosslink of the polymer is advanced due to water content, processing can be performed even under a normal pressure environment (in the atmosphere or in a constant temperature with high humidity). The polymer used for the extrusion coating is hardly bitten into meshes of a braided shield under the normal pressure environment, and there is no risk of excessively adhering to the braided shield. Thus, separators can be omitted (reduced), and the flexibility of the electric insulation cable with shield can be improved.

Further, even in a case of a thick sheath or insulating layer, a uniform crosslink is achieved uniformly in a thickness direction.

The present invention is provided based on the above-mentioned knowledge.

### 2. First Embodiment of the Present Invention

A first embodiment of the present invention will be described hereafter.

[2-1. Electric Insulation Cable with Shield]

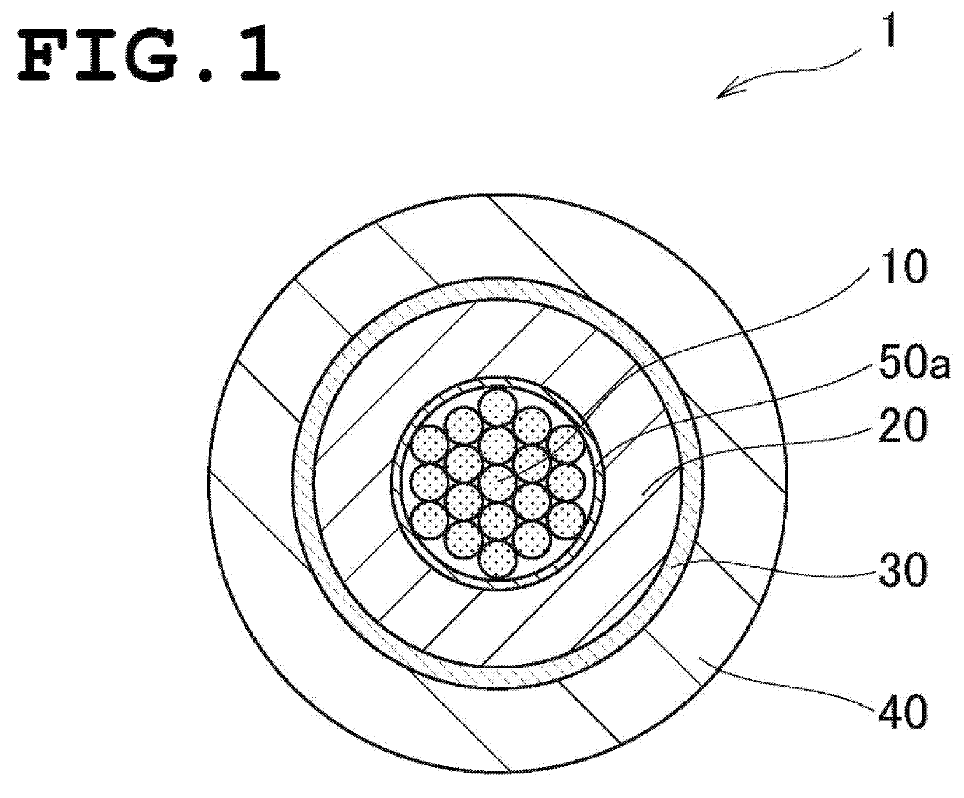

FIG. 1 is a cross-sectional view of an electric insulation cable with shield according to a first embodiment of the present invention.

As shown in FIG. 1, in an electric insulation cable with shield of this embodiment (called simply an electric insulation cable 1 hereafter), the following case is shown: namely, an insulating layer 20 is crosslinked by organic peroxide, and a sheath 40 is silane-crosslinked, and an inner layer separator 50a is provided only between conductors 10 and the insulating layer 20. Specifically, in the electric insulation cable 1, the inner layer separator 50a, the insulating layer 20, a braided shield 30, and a sheath 40 are provided on the outer periphery of the conductors 10 in this order.

### <Conductor 10>

Each conductor 10 is made of a material capable of transmitting an electric signal, and specifically, is made of a metal wire having a diameter of about several hundreds μm. For example, the conductor 10 is made of the metal wire including a metal material such as copper, a copper alloy, silver or aluminum, etc. Further, metal plating may be applied to a surface of the metal wire from a viewpoint of improving heat-resistance. As the metal plating, for example, tin plating, nickel plating, silver plating, and gold plating, etc., can be used. The electric insulation cable 1 includes one or a plurality of conductors 10 in the vicinity of its center. When the plurality of conductors 10 are provided, the plurality of conductors 10 are exemplarily intertwined.

<Inner Layer Separator 50a>

An inner layer separator 50a is provided so as to be interposed between the insulating layer 20 which is crosslinked by organic peroxide described later, and the conductors 10, to thereby suppress adhesion to the conductors 10. The inner layer separator 50a is formed by winding a film made of nylon, polyester, and fluorine-based resin, etc., paper or cloth, etc., around an outer periphery of the conductors 10.

### <Insulating Layer 20>

The insulating layer 20 is provided on the outer periphery of the inner layer separator 50a. The insulating layer 20 is formed by extrusion-coating of a specific polymer including organic peroxide on an outer periphery of the inner layer separator 50a and applying crosslink processing thereto under a high temperature and high pressure environment. In this embodiment, although the crosslink processing is applied to the insulating layer 20 under the high temperature and high pressure environment, the insulating layer 20 is provided on the outer periphery of the conductors 10 through the inner layer separator 50a, and therefore the adhesion is suppressed. Note that the polymer similar to the polymer constituting the sheath 40 described later, is exemplary as the polymer constituting the insulating layer 20, and for example, non-halogen rubber or ethylene-based copolymer can be used.

### <Braided Shield 30>

A braided shield 30 is provided on the outer periphery of the insulating layer 20. The braided shield 30 is formed by weaving a plurality of wires such as a soft copper wire, etc., and has a specific mesh structure. The braided shield 30 has a shield performance of shielding a noise generated when a current flows through the conductors 10, and has a specific flexibility by this mesh structure.

### <Sheath 40>

A sheath 40 is provided on the outer periphery of the braided shield 30. The sheath 40 is formed by extrusion-coating of the specific non-halogen composition on the outer periphery of the braided shield 30, and silane-crosslinking applied thereafter under a normal pressure, and is made of a silane-crosslinked composition in which a specific non-halogen composition is silane-crosslinked. The sheath 40 is not excessively adhered to the braided shield 30 because it is made of the specific silane-crosslinked composition. Thus, the sheath 40 is provided immediately on the braided shield 30. Further, since the antioxidant is not consumed during silane-crosslinking process, the content of the antioxidant is not required to be increased in consideration of a consumed amount. Thus, the sheath 40 has an excellent heat resistance, and reduction of flame retardancy is suppressed, which is caused by including the antioxidant. In addition, since the reduction of the flame retardancy is suppressed, the content of the flame retardant agent is not required to be increased for compensating its reduction, and reduction of mechanical characteristics and flexibility of the sheath 40 is suppressed, which is caused by including the flame retardant agent.

### (Non-Halogen Composition)

The non-halogen composition used for the sheath 40 will be described hereafter.

The non-halogen composition includes 100 pts.mass of silane-grafted polymer (A) obtained by graft copolymerizing a silane compound to the polymer including at least one of non-halogen rubber and ethylene-based copolymer, and 1 pts.mass or more and 10 pts.mass or less of an antioxidant (B).

### (Silane-Grafted Polymer (A))

The silane-grafted polymer (A) has a silane-crosslinkable structure, and is obtained by causing a reaction of polymer including 100 pts.mass in total of 0 pts.mass or more and 100 pts.mass of non-halogen rubber (a1) and 0 pts.mass or more and 100 pts.mass or less of ethylen-based copolymer (a2), a silane compound, and a free radical generator being a reaction initiator.

The non-halogen rubber (a1) is not particularly limited, provided that it is an amorphous and halogen-free rubber, and for example ethylene-propylene copolymer rubber (EPR), ethylene-propylene-diene terpolymer (EPDM), acrylonitrile-butadiene rubber (NBR), hydrogen-added NBR (HNBR), acryl rubber, butadiene-styrene copolymer rubber (SBR), isobtylene-isoprene copolymer rubber (IIR), and block copolymer rubber having a polystyrene block, urethane rubber, and phosphazene rubber, etc., can be given. These rubbers may be used alone or may be used by mixing two kinds or more of them.

The ethylene-based copolymer (a2) is not particularly limited, provided that it is a crystalline halogen-free rubber, and for example ethylene-acrylic acid ester copolymer, ethylene-octene copolymer (EOR), ethylene-vinyl acetate copolymer (EVA), acrylate-ethylene copolymer (EEA), ethylene-acrylic acid methyl copolymer (EMA), ethylene-acrylic acid butyl copolymer (EBA), ethylene-1-butene copolymer (EBR), High Density Polyethylene, Linear Low Density Polyethylene, Low Density Polyethylene, Ultra Low Density Polyethylene, and Polypropylene, etc., can be given. These rubbers may be used alone or may be used by mixing two kinds or more of them.

The graft-copolymerized silane compound is not particularly limited, provided that it has a group that can react with polymer such as non-halogen rubber (a1), etc., and an alkoxy group that forms the silane crosslink structure by a silanol condensation. For example, vinyl compounds such as trimethoxyvinylsilane, triethoxyvinylsilane, and vinyltris(β-methoxyethoxy)silane, etc., aminosilane compounds such as γ-aminopropyltrimethoxysilane, γ-aminopropyltriethoxysilane, N-β-(aminoethyl)γ-aminopropyltrimethoxysialne, β-(aminoethyl)γ-aminopropylmethyldimethoxysilane, N-phenyl-γ-aminopropyltrimethoxysilane, etc., epoxysilane compounds such as β-(3,4-epoxycyclohexyl)ethyltrimethoxysilane, γ-glycidoxypropyltrimethoxysialne, γ-glycidoxypropylmethyldiethoxysialne, etc., acyrylsilane compounds such as γ-methacryloxypropyltrimethoxysilane, polysulfide silane compounds such as bis(3-(triethoxycyril) propyl)disulfide, bis(3-(triethoxycyril)propyl)tetrasulfide, etc., and mercaptosilane compounds such as 3-mercaptopropyltrimethoxysialne, 3-mercaptopropyltriethoxysilane, etc., can be given.

As the free radical generator that graft-copolymerizes the silane compound, for example, organic peroxides that is decomposed by heat of dicumyl peroxide, benzoyl peroxide, 1,1-bis(t-butyl peroxide)-3,3,5-trimethylcyclohexan, t-butylperoxideoxyisopropylcarbonte, t-butylperoxidebemzpate. 2,5-dimethyl 2,5-bis(benzoylperoxy)hexane, methylethylketoneperoxide, 2,2-bis(t-butylperoxy)butane, and cumene hydroperoxide, etc., and generates free radicals, can be used.

Note that addition amounts of the silane compounds and the free radicals are not particularly limited, and can be suitably varied according to a target crosslinking degree in the sheath 40.

### (Antioxidant (B))

The antioxidant (B) suppresses oxidation and deterioration of the polymer due to heat and light, and improves the thermal stability of the non-halogen composition. The oxidation and deterioration of the polymer starts from the reaction which generates alkyl radicals (R.) due to light and heat, and is advanced by generating substances rich in reactivity in a chain reaction, such as peroxy radical (ROO.), hydroperoxy radical (ROOH) generated by extracting hydrogen from other polymer molecule by the peroxy radical, and alkoxy radical (RO.) generated by decomposing the hydro peroxide. The antioxidant (B) captures and decomposes such chain-generated radicals, then suppresses the oxidation and deterioration of the polymer, and improves the thermal stability.

The content of the antioxidant (B) is 1 pts.mass or more and 10 pts.mass or less, and preferably 1 pts.mass or more and 7.5 pts.mass or less, with respect to 100 pts.mass of silane-grafted polymer (A). In this embodiment, due to the silane-crosslinking of the non-halogen composition, the radicals are not generated during the crosslinking reaction, and the antioxidant (B) is not consumed during the crosslinking reaction. Thus, in the non-halogen composition, even in a case of a small content of the antioxidant (B), prescribed thermal stability can be obtained. Further, the antioxidant (B) has a low molecular weight, and therefore there is a risk of reducing the flame retardancy of the non-halogen composition. However, in this embodiment, the content of the antioxidant (B) is small, and therefore reduction of the flame retardancy caused by the antioxidant (B) can be suppressed.

The antioxidant (B) is not particularly limited, and a primary antioxidant agent for stabilization by capturing the peroxyradical and the alkoxy radical, etc., for example generated when oxidation and deterioration occurs, or a secondary antioxidant for decomposing the hydroperoxide, can be used. The primary antioxidant and the secondary antioxidant are exemplarily used together, from a viewpoint of improving the thermal stability of the non-halogen composition. Thus, the chain reaction can be further suppressed when oxidation and deterioration occurs.

A combination of the primary antioxidant and the secondary antioxidant is particularly not limited. However, a hindered phenol compound (b1) as the primary antioxidant and a thioether compound (b2) as the secondary antioxidant are exemplarily used together. When using them together, total of the hindered phenol compound (b1) and the thioether compound (b2) is set to 1 pts.mass or more and 10 pts.mass or less. The ratio of them is not particularly limited, but the ratio (b1)/(b2) of the hindered phenol compound (b1) to the thioether compound (b2) is preferably set to 1 or more and 6 or less.

As the hindered phenol compound (b1), for example, pentaetythritol tetrakis[3-3,5-di-tert-butyl-4-hydroxyphenyl)propionate], thiodiethylenebis[3-(3,5-di-tert-butyl-4-hydroxyphenyl)propionate], octadecyl-3-(3,5-di-tert-butyl-4-hydroxyphenyl)propionate, N,N′-hexan-1,6-diylbis[3-(3,5-di-tert-butyl-4-hydroxy phenyl)propionamido], benzene propaonio acid, 3,5-bis(1,1-dimethylethyl)-4-hydroxy, C7-C9 alkyl ester side chain, 3,3′.3″5,5″-hexya-tert-butyl-a,a′.a″-(methylene-2,4,6-triyl)tri-p-cresol, 4,6-bis(octyl thiomethyl)-o-cresol, 4,6-bis(dodecylthiomethyl)-o-cresol, ethylene bis(oxiethylene)bis[3-(5-tert-butyl-4-hydroxy-m-tril)propionate], hexamethylenebis[3-(3,5-di-tert-butyl-4-hydroxyphenyl)propionate], 1,3,5-tris(3,5-di-tert-butyl-4-hydroxybenzil)-1,3,5-triazine-2,4,6(1H,3H,5H)-trione, 1,3,5-tris[(4-tert-butyl-3-hydroxy-2,6-xylyl)methyl]-1,3,5-triazine-2,4,6(1H,3H,5H)-trione, 2,6-di-tert-butyl-4-(4,6-bis(octylthio)-1,3,5-triazine-2-ylamino)phenol, hinderedphehol, hinderedbisphenol, etc., can be given. These compounds may be used alone, or two kinds or more of them may be mixed and used.

As the thioether compound (b2), for example, dilauryl-3,3′-thiodipropionate, dimyristyl-3,3′-thiodipropionate, distearyl-3,3′-thiodipropionate, pentaerythritol tetrakis(3-laurylthiopropionate), ditridecyl-3,3′-thiodipropionate, sulfur-containing ester-based compound, 1,1′-thiobis(2-naphtol), etc., can be given. These compounds may be used alone or two kinds or more of them may be mixed and used.

### (Flame Retardant Agent (C))

The non-halogen compound includes at least the silane-grafted polymer (A) and the antioxidant (B) as essential components. However, it is exemplary to further include a flame retardant agent (C) from the viewpoint of improving the flame retardancy. The flame retardant agent (C) is not particularly limited, and a metal hydroxide-based flame retardant agent such as magnesium hydroxide and aluminium hydroxide, nitrogen-based flame retardant agent such as melamine cyanurate, phosphoric flame retardant agent such as red phosphorus and phosphate ester, and zinc-based flame retardant agent such as hydroxy zinc stannate and zinc borate, etc., can be given, and these flame retardant agents may be used alone or two kinds or more of them may be used together. Surface treatment may be applied to the flame retardant agent (C) by a silane coupling agent, a titanate-based coupling agent, and a fatty acid such as stearic acid, from the viewpoint of improving dispersability. Further, in order to further improve the flame retardancy, an aromatic azo-compound may be included as a flame retardant aid, together with the flame retardant agent (C). According to the aromatic azo-compound, generation of a hard shell is accelerated on the surface of the sheath 40 during incineration of the electric insulation cable 1, and supply of oxygen from outside and dispersion of a flammable gas can be suppressed.

The content of the flame retardant agent (C) can be suitably varied according to the flame retardancy required for the non-halogen composition. As described above, since the content of the antioxidant (B) is small in the non-halogen composition, reduction of the flame retardancy caused by the antioxidant (B), is suppressed. Therefore, there is no necessity for increasing the content of the flame retardant agent (C) for compensating the flame retardancy, and the content of the flame retardant agent (C) can be reduced. Specifically, the content of the flame retardant agent (C) is preferably set to 10 pts.mass or more and 150 pts.mass or less, with respect to 100 pts.mass of the silane-grafted polymer (A). In the non-halogen composition of this embodiment, excellent flame retardancy can be obtained even in a case of a small content of the flame retardant agent (C). In addition, reduction of the mechanical characteristics and flexibility due to the content of the flame retardant agent (C) is suppressed, and the mechanical characteristics and the flexibility are also excellent.

### (Other Addition Agents)

Addition agents other than the above-mentioned agents, may be included in the non-halogen composition. As other agents, for example, processing oil, processing aids, flame retardant aid, crosslinking aid, ultraviolet absorber, copper inhibitor, lubricant, inorganic filler, compatibilizer, stabilizer, carbon black, and colorant, etc., can be given.

### (Silane-Crosslinked Composition)

The silane-crosslinked composition constituting the sheath 40, is formed by crosslinking the above-mentioned non-halogen composition under the normal pressure.

The silane-crosslinked composition has a specific thermal stability even if the content of the antioxidant (B) is small, because the antioxidant (B) is not consumed. Specifically, in the silane-crosslinked composition, even if the content of the antioxidant (B) is small to be 1 pts.mass or more and 10 pts.mass or less, and an oxidation inducing period at 230° C. is 100 minutes or more, which is an index of the thermal stability. As shown in an example described later, the oxidation inducing period shows a period until the silane-crosslinked composition starts to be oxidized and deteriorated, and as the oxidation inducing period is longer, the thermal stability is more excellent.

In addition, the content of the antioxidant (B) is small and the reduction of the flame retardancy is suppressed, which is caused by including the antioxidant (B), and therefore the content of the flame retardant agent (C) can be reduce, which is required for compensating and improving the reduced flame retardancy. Specifically, even if the content of the flame retardant agent (C) is small to be 10 pts.mass or more and 150 pts.mass or less, the silane-crosslinked composition has the flame retardancy of realizing a self-extinguishing performance within 70 seconds in a flame retardancy test based on ISO6722.

Meanwhile, in a case of a sheath crosslinked by organic peroxide or electron beam irradiation, the antioxidant is consumed, and therefore there is a necessity for increasing the content of the antioxidant, more than at least 10 pts.mass, to set the oxidation inducing period within the above-mentioned range. Therefore, the flame retardancy of the sheath is greatly reduced by increasing the content of the antioxidant. In order to compensate and improve the reduced flame retardancy, the content of the flame retardant agent is required to be increased, at least more than 150 pts.mass. However, if the content of the flame retardant agent is increased more than 150 pts.mass, the mechanical characteristics and the flexibility of the sheath are deteriorated. Meanwhile, if the content of the antioxidant is set to 10 pts.mass or less so as not to increase the content of the flame retardant agent, the antioxidant is consumed and the specific thermal stability cannot be obtained.

Note that in order to accelerate the crosslinking reaction in the silane crosslinking process, a silanol condensation catalyst may be included in the non-halogen composition. As the silanol condensation catalyst, metal compounds such as dibutyltin dilaurate, dioctyltin dilaurate, dibutyltin diacetate, dioctyltin diacetate, dibutyltin dioctoate, dioctyltin dioctoate, stannous acetate, tinoctanoate, zinc caprylate, zinc naphthenate, cobalt naphthenate; acids such as carboxylic compounds, alkylbenzenesulfonate including dodecylbenzenesulfonate, and alkylnaphthalenesulfonate including dodecylnaphthalenesulfonate; and alkali such as an amine-based compound, etc., can be given. These catalysts may be used alone or two kinds or more of them may be used together. An addition amount of the silanol condensation catalyst is different depending on the kind, and is preferably set to 0.001 pts.mass or more and 1.0 pts.mass or less with respect to 100 pts.mass of the silane-grafted polymer (A). An addition method of the silanol condensation catalyst includes a method of using a masterbatch which is previously mixed into the non-halogen rubber and ethylene-based copolymer, other than a method of adding the silanol condensation catalyst as it is.

[2-2. Manufacture of the Electric Insulation Cable 1 with Shield]

A method of manufacturing the electric insulation cable 1 will be described next. Hereafter, first, the non-halogen composition used for the sheath 40 is prepared, and thereafter the electric insulation cable 1 is manufactured using this non-halogen composition.

### (Preparation of the Silane-Grafted Polymer (A))

First, the silane-grafted polymer (A) as a base of the non-halogen composition, is prepared.

The silane-grafted polymer (A) can be prepared by a publicly-known method. For example, polymer including at least one of the non-halogen rubber and the ethylene-based copolymer is charged into a single screw extruder or a twin screw extruder, and thereafter a mixed solution of the silane compound and the free radical generator is injected into a cylinder using a liquid feed pump, etc., to thereby cause a reaction. The silane compound is graft-copolymerized to the polymer by this reaction, to thereby obtain the silane-grafted polymer (A). A temperature of an extruder and a retention time, etc., can be given as reaction conditions, and these conditions can be suitably changed from a viewpoint of a relation between the temperature and a half-life of the free radical generator.

As the preparation of the silane-grafted polymer (A), the polymer and the silane compound, and the free radical generator are previously blended and are collectively charged into a hopper, to thereby cause a reaction.

### (Preparation of the Non-Halogen Composition)

Subsequently, the non-halogen composition is prepared using the obtained silane-grafted polymer (A). For example, 100 pts.mass of the silane-grafted polymer (A) and 1 pts.mass to 10 pts.mass of the antioxidant (B) are kneaded using a kneading device such as a kneader or a banbury mixer, and twin screw extruder, etc. In this case, 10 pts.mass or more and 150 pts.mass or less of the flame retardant agent (C) or the silanol condensation catalyst, etc., may be added as needed. Although a kneading order of the addition agent is not particularly limited, the addition agent is exemplarily added when the non-halogen composition described later is used for extrusion-coating, because the silane crosslinking reaction is advanced when adding the silanol condensation catalyst. Such an addition method includes a method of charging the silanol condensation catalyst as it is or by blending it into the non-halogen composition from a hopper in the form of a masterbatch, or a method of side-feeding in the middle of the process.

(Manufacture of the Electric Insulation Cable 1 with Shield)

In this embodiment, the insulating layer 20 is crosslinked by organic peroxide, and the sheath 40 is crosslinked by silane-crosslinking. Therefore, as shown in FIG. 1, the electric insulation cable 1 with a separator interposed between the conductors 10 and the insulating layer 20, is manufactured.

First, the inner layer separator 50a is formed by winding a film, etc., around the outer periphery of the conductors 10. Subsequently, the insulating layer 20 having a thickness of 1 mm for example, is formed by extrusion-coating the outer periphery of the inner layer separator 50a, with polymer such as non-halogen rubber or ethylene-based copolymer and the polymer composition including the organic peroxide. The crosslinking processing is applied to the insulating layer 20 by exposing the insulating layer 20 under a steam environment at high temperature and high pressure. Then, a braided shield 30 formed by weaving metal wire, is formed on the outer periphery of the insulating layer 20. Thereafter, the prepared non-halogen composition is used for extrusion-coating the outer periphery of the braided shield 30, to thereby form a sheath 40 having a thickness of 1.2 mm for example. Then, the sheath 40 is exposed in the atmosphere under the normal pressure or in a constant temperature chamber with high humidity, and the silane crosslinking of the sheath 40 is advanced, to thereby obtain an electric insulation cable 1 of this embodiment. The crosslinking processing in the constant temperature chamber with high humidity is exemplary, from a viewpoint of accelerating a crosslinking speed of the silane crosslinking, and for example crosslinking for about 24 hours under an environment of 90% RH at 80° C. is exemplary.

### 3. Second Embodiment of the Present Invention

In the above-mentioned first embodiment, explanation is given for a case that crosslinking processing is applied to the insulating layer 20 using the organic peroxide. However, the present invention is not limited thereto. In the present invention, silane-crosslinking can also be applied to the insulating layer 20, and the non-halogen composition used for the sheath 40 can also be used for the insulating layer 20. Thus, the insulating layer 20 can be provided immediately on the outer periphery of the conductors 10, without providing the separator between the conductors 10 and the insulating layer 20.

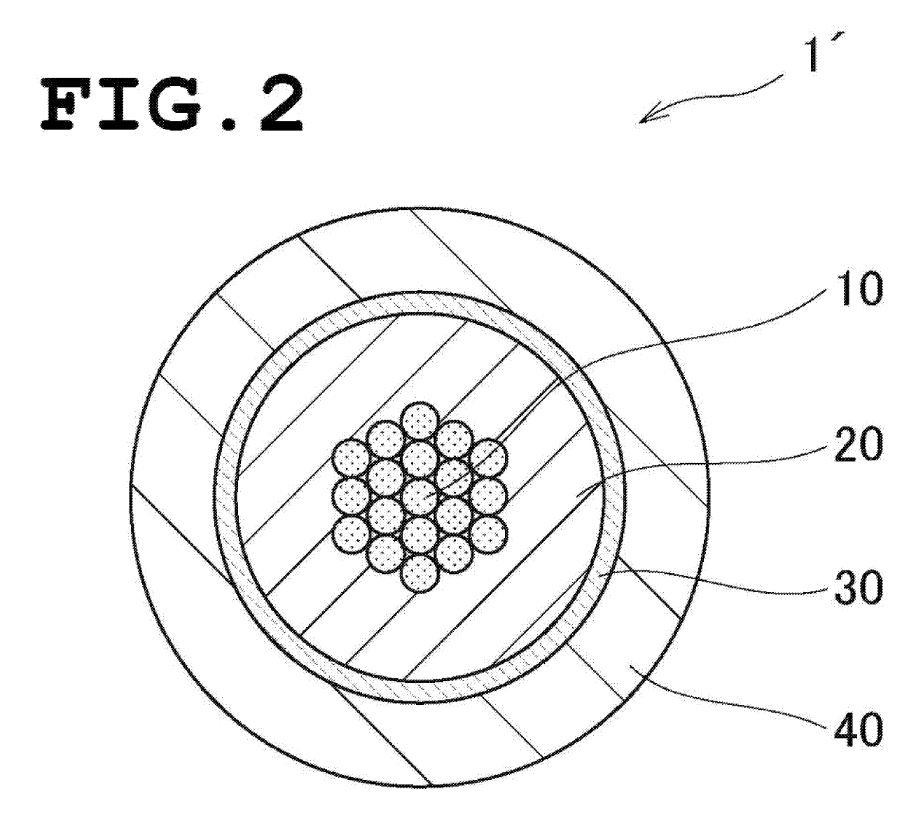

Specifically, as shown in FIG. 2, the insulating layer 20, the braided shield 30, and the sheath 40 are provided on the outer periphery of the conductors 10 in this order in an electric insulation cable 1′. The insulating layer 20 is provided immediately on the outer periphery of the conductors 10, because excessive adhesion to the conductors 10 does not occur by forming the insulating layer 20 using the silane-crosslinked composition which is the silane-crosslinked non-halogen composition. In the electric insulation cable 1′ of this embodiment, flexibility can be further improved by omitting the inner layer separator 50a.

### EXAMPLE

An example of the present invention will be described next. In this example, the non-halogen composition was prepared, and the electric insulation cable is manufactured using this non-halogen composition. Then, evaluation was performed to the manufactured electric insulation cable. These examples are one of the examples of the electric insulation cable of the present invention, and the present invention is not limited to these examples.

### (1) Materials

Materials used in the following examples and comparative examples, are described below.

The following material was used as the non-halogen rubber (a1).
Ethylene-propylene-diene terpolymer rubber: “EPT1045” by Mitsui Chemicals.Inc.

The following material was used as the ethylene-based copolymer (a2).
Ethylene-vinyl acetate: “EVAFLEX EV170” by Mitsui Polychemicals Company, Ltd.
Ethylene-methyl acrylate copolymer: “Elvaloy 1125AC” by Mitsui Polychemicals Company, Ltd.

The following material was used as the antioxidant (B).
Hindered phenol compound (b1): IRGANOX 1010″ by CHIBA JAPAN
Thioether compound (b2): “SEANOX 412A” by SHIPRO CO.

The following material was used as the flame retardant agent (C).
Magnesium hydroxide: “KISMA” by Kyowa Chemical Industry Co., Ltd.

The following material was used as other addition agent (D).
Aromatic azo-compound (d1): 2-[[1-[[[(2,3-dihydro-2-oxo-1H-benzoimidazole)-5-yl]amino]calbonyl]-2-oxopropyl]azo]benzoic acid
Aromatic azo compound (d2):2-[hydroxy-3-[[(2,3-dihydro-2-oxo-1H-benzoimidazole)-5-yl]carbamoyl]-1-naphthylazo]benzoic acid butyl
Copper inhibitor (d3): “CUNOX” by MITUSI FINE CHEMICALS.INC.
Organic peroxide (d4): 1,3-bis(2-t-butylperoxyisopropyl)benzene, “Perkadox 14” by Kayaku Akzo Co., LTD.

The following material was used as the silanol condensation catalyst (masterbatch).
Ethylene-acrylic acid methyl copolymer: “Elvaloy 1125AC” by Du Pont-Mitsui chemical Co. Ltd.
Dioctyltin dilaurate: “NEOSTANN U-810” by NITTO CHEMICAL INDUSTRY CO., LTD

### (2) Preparation of the Non-Halogen Composition

Prior to the preparation of the non-halogen composition, the silane-grafted polymer (A) was prepared by graft-copolymerizing the silane compound to the non-halogen rubber (a1) or the ethylene-based copolymer (a2). In this example, as shown in table 1, three kinds of the silane-grafted polymers (A1) to (A3) were prepared. Specifically, a prescribed amount of vinyltrimethoxysilane (“KBM1003” by Shin-Etsu Chemical Co., Ltd.) is charged into the 40 mm single screw extruder (L/D=24) of 200° C. as the polymer and the silane compound including at least one of the non-halogen rubber (a1) and the ethylene-based copolymer (a2), and a prescribed amount of dicumyl peroxide (“percumyl D” by NOF CORPORATION) is charged thereinto as the free radical, and extrusion is carried out so that the retention time is about 5 minutes, to thereby prepare the silane-grafted polymers (A1) to (A3).

TABLE 1

| | | Silane-grafted polymer | | |
|---|---|---|---|---|
| | | (A1) | (A2) | (A3) |
| Non-halogen | Ethylene-propylene-diene | 100 | — | — |
| rubber (a1) | terpolymer | | | |
| Ethylene-based | Ethylene-vinyl acetate | — | 100 | — |
| copolymer (a2) | copolymer | | | |
| | Ethylene-acrylic acid methyl | — | — | 100 |
| | copolymer | | | |
| Silane compound | Vinyltrimethoxysilane | 3 | 3 | 3 |
| Free radical | Dicumyl peroxide | 0.1 | 0.1 | 0.1 |
| generator | | | | |

Subsequently, non-halogen compositions A to I were prepared using the obtained silane-grafted polymers (A1) to (A3). Specifically, prescribed amounts of silane-grafted polymers (A1) to (A3), antioxidants (B), flame retardant agents (C), and other addition agents were charged into a kneader (25 litters), which were then kneaded and pelletized at a kneading temperature of 100° C., to thereby prepare the non-halogen composition as a cable extruding source. Regarding the silanol condensation catalyst (masterbatch), the materials were not added in this stage, but were added when extrusion-coating was performed as described later. The non-halogen compositions A to I are shown in table 2 as follows.

TABLE 2

| | | A | B | C | D | E | F | G | H | I |
|---|---|---|---|---|---|---|---|---|---|---|
| Polymer | Silane-grafted polymer | 100 | 100 | — | — | 50 | 50 | 50 | — | — |
| | (A1) | | | | | | | | | |
| | Silane-grafted polymer | — | — | 100 | 100 | — | — | — | — | — |
| | (A2) | | | | | | | | | |
| | Silane-grafted polymer | — | — | — | — | 50 | 50 | 50 | — | — |
| | (A3) | | | | | | | | | |
| | Non-halogen rubber (a1) | — | — | — | — | — | — | — | 50 | 50 |
| | (Ethylene-propylene- | | | | | | | | | |
| | diane terpolymer | | | | | | | | | |
| | rubber) | | | | | | | | | |
| | Ethylen-based copolymer | — | — | — | — | — | — | — | 50 | 50 |
| | (a2) | | | | | | | | | |
| | (Ethylene-acrylic acid | | | | | | | | | |
| | methyl copolymer) | | | | | | | | | |
| Antioxidant (B) | Hindered phenol | 0.5 | 0.45 | 8.4 | 9 | 2 | 1 | 2 | 2 | 2 |
| | compound (b1) | | | | | | | | | |
| | Thioether compound (b2) | 0.5 | 0.45 | 1.4 | 1.5 | 1 | 0.5 | 1 | 1 | 1 |
| Flame | Magnesium hydroxide | 120 | 120 | 120 | 120 | 120 | 90 | 120 | 120 | 120 |
| retardant | | | | | | | | | | |
| agent (C) | | | | | | | | | | |
| Other addition | Aromatic azo-compound | — | — | — | — | — | — | 2 | — | — |
| agent (D) | (d1) | | | | | | | | | |
| | Aromatic azo-compound | — | — | — | — | — | — | 1 | — | — |
| | (d2) | | | | | | | | | |
| | Copper inhibitor (d3) | 0.5 | 0.5 | 0.5 | 0.5 | 0.5 | 0.5 | 0.5 | 0.5 | 0.5 |
| | Organic peroxide (d4) | — | — | — | — | — | — | — | 2 | — |
| Silanol | Ethylene-acrylic acid | 4.95 | 4.95 | 4.95 | 4.95 | 4.95 | 4.95 | 4.95 | — | — |
| condensation | methyl copolymer | | | | | | | | | |
| catalyst | Dioctyltin dilaurate | 0.05 | 0.05 | 0.05 | 0.05 | 0.05 | 0.05 | 0.05 | — | — |
| (masterbatch) | | | | | | | | | | |

| | | | | | | | | | |
|---|---|---|---|---|---|---|---|---|---|
| Crosslinking system | silane | silane | silane | silane | silane | silane | silane | organic | electron |
| | crosslink | crosslink | crosslink | crosslink | crosslink | crosslink | crosslink | peroxide | base |
| | | | | | | | | | irradiation |

As shown in table 2, non-halogen compositions A to I with different crosslinking systems were prepared. Non-halogen compositions A to G are silane-crosslink, and non-halogen composition H is the crosslink by organic peroxide, and non-halogen composition I is the crosslink by electron beam irradiation. Specifically, non-halogen compositions A to E were prepared by suitably varying the content of the antioxidant (B). Similarly, non-halogen composition F was prepared, excluding a point that the content of the flame retardant agent (C) is more reduced than those of the non-halogen compositions A to E. Non-halogen composition G was prepared similarly to the non-halogen composition E, excluding a point that the aromatic azo-compounds (d1) and (d2) were further used as flame retardant agents. Non-halogen rubber (a1) was prepared by including the organic peroxide (d4) in 50 pts.mass of ethylene-propylene-diene terpolymer as the non-halogen rubber (a1), and 50 pts.mass of ethylene-acrylic acid methyl copolymer as the ethylene-based copolymer (a2), without using silane-grafted polymers (A1) to (A3). Non-halogen composition I was prepared similarly to the non-halogen composition H, excluding a point that the organic peroxide (d4) was not included.

### (3) Manufacture of the Electric Insulation Cable

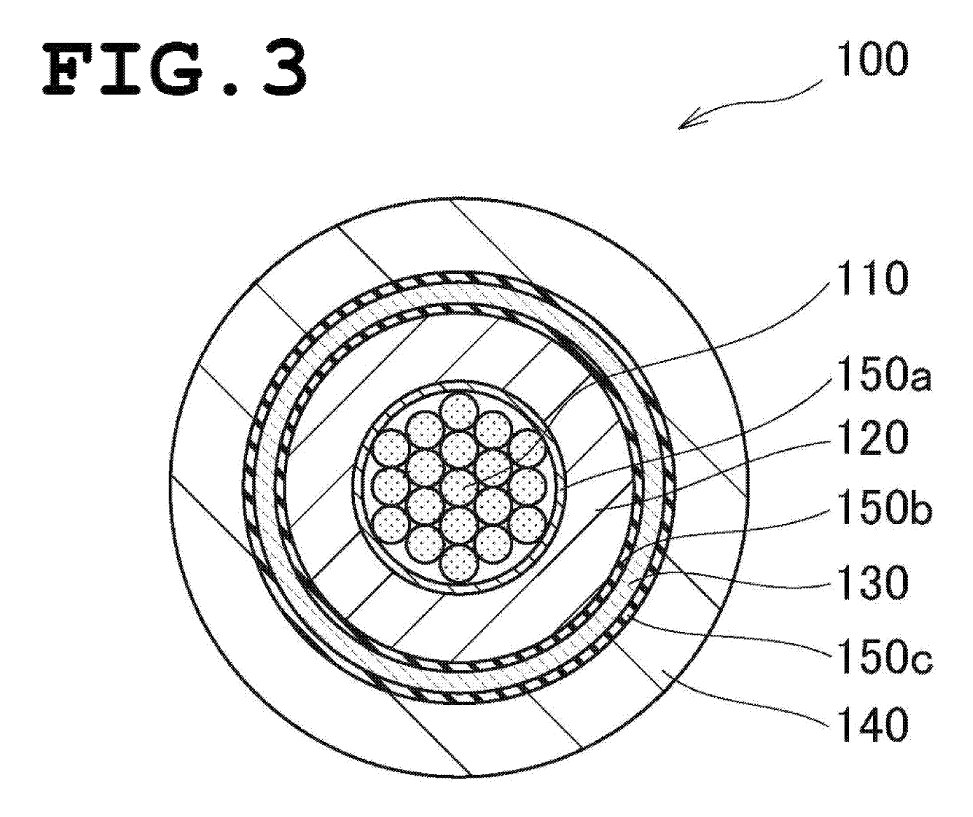

Subsequently, the electric insulation cable having the structure shown in FIG. 1 to FIG. 3 was manufactured, using the above obtained non-halogen compositions A to I. FIG. 1 shows a structure including an inner layer separator only, and FIG. 2 shows a structure not including separators, and FIG. 3 shows a structure including the inner layer separator, a middle separator, and an outer layer separator.

In example 1, the electric insulation cable having the structure shown in FIG. 2, was manufactured. Specifically, the non-halogen composition A was extruded on the outer periphery of the conductors in a thickness of 1 mm, together with the silanol condensation catalyst (masterbatch), and an insulating layer having a thickness of 1 mm was formed by the silane crosslinking process for about 24 hours under an environment of 90% RH at 80° C. Subsequently, a braided shield was formed on the outer periphery of the insulating layer. Thereafter, the outer periphery of the braided shield was extrusion-coated with the non-halogen composition A in a thickness of 1.2 mm, to thereby form a sheath, and similarly to the insulating layer, an electric insulation cable of example 1 was manufactured by a silane-crosslinking process.

Conductors (having a cross-sectional area of 35 mm²) in which tin-plated copper wires were twisted, were used as the conductors. Such twisted conductors were obtained by twisted tin-plated copper wires so as to be nineteen parent twisted wires, thirty-five child twisted wires, and having a wire diameter of 0.26 mm. The braided shield was formed by kneading into the insulating layer so that a braided density was 90% or more, using a tin-plated copper wire having a wire diameter of 0.12 mm.

In example 2, the inner layer separator was provided on the outer periphery of the conductors, and the insulating layer was formed thereon using non-halogen composition H, to thereby manufacture the electric insulation cable having the structure shown in FIG. 1. Specifically, the inner layer separator was formed by winding a polyethylene-telephthalate tape having a thickness of 38 μm and a width of 25 mm, by ¼ wrap around the outer periphery of the conductors. Thereafter, an insulating layer was formed by extrusion-coating it with the non-halogen composition H of a crosslinking system by organic peroxide, and crosslinking processing was applied thereto for 5 minutes by high pressure steam of 1.8 MPa. Subsequently, a braided shield was formed on the outer periphery of the insulating layer, and the outer periphery was extrusion-coated with non-halogen composition A to thereby form a sheath, and an electric insulation cable of example 2 was manufactured by crosslinking.

In examples 3 to 6, an electric insulation cable having the structure shown in FIG. 2 was manufactured similarly to example 1, excluding a point that the non-halogen composition used for an insulating layer and a sheath was suitably varied.

In comparative example 1, an electric insulation cable having the structure shown in FIG. 3 was manufactured. Specifically, the inner layer separator was formed by winding the polyethylene-telephthalate tape having the thickness of 38 μm and the width of 25 mm, by ¼ wrap around the outer periphery of the conductors. Thereafter, an insulating layer was formed by extrusion-coating it with non-halogen composition H of the crosslinking system by organic peroxide, and crosslinking processing was applied thereto for 5 minutes by high pressure steam of 1.8 MPa. Subsequently, the inner layer separator was formed on the outer periphery of the insulating layer similarly to the inner layer separator. Subsequently, a braided shield was formed on the outer periphery of the middle separator. Subsequently, an outer layer separator was formed on the outer periphery of the braided shield similarly to the inner layer separator. Subsequently, the outer periphery of the braided shield was extrusion-coated with the non-halogen composition H to thereby form a sheath, and an electric insulation cable of comparative example 1 was manufactured by crosslinking similarly to the insulating layer.

In comparative example 2, an electric insulation cable having the structure shown in FIG. 2 was manufactured similarly to comparative example 1, excluding a point that the middle separator and the outer layer separator were not formed.

In comparative example 3, an insulating layer and a sheath were formed using non-halogen composition I of a crosslinking system by electron beam irradiation, to thereby manufacture an electric insulation cable having the structure shown in FIG. 2. In a case of the crosslinking by electron beam irradiation, the insulating layer or the sheath was formed by extrusion-coating of the non-halogen composition I, and thereafter crosslinking was applied thereto by irradiating the insulating layer or the sheath with electron beams at 150 kGy.

In comparative example 4 and comparative example 5, an electric insulation cable was manufactured similarly to example 1, excluding a point that an insulating layer or a sheath was formed using non-halogen composition B or D of a silane-crosslinking system.

### (4) Evaluation Method

The manufactured electric insulation cable was evaluated by the following method.

### (Adhesion)

In this example, in order to evaluate a folding workability of the braided shield, adhesivity between the insulating layer and the braided shield was evaluated. Specifically, a sample in a contact state of the insulating layer and the braided shield was prepared, and this sample was cut out into 12.5 mm width, to fabricate a sample for evaluation. T-peel test of 50 mm/min tensile speed was performed using this sample, and its peeling strength was measured. In this example, when the peeling strength was 0.5N/mm or less, this case was regarded as success in which the folding workability of the braided shield was excellent, and when the peeling strength was beyond 0.5N/mm, this case was regarded as failure in which the folding workability was difficult.

### (Flexibility)

Flexibility of the electric insulation cable was evaluated by fixing one end of the electric insulation cable having a length of 200 mm and measuring a slacking amount of the electric insulation cable (distance reduced from a horizontal surface) when adding a load of 10 g to another end. A larger slacking amount shows excellent flexibility, and in this example, when the slacking amount was 35 mm or more, this case was regarded as success, and when the slacking amount was less than 35 mm, this case was regarded as failure.

### (Heat Resistance)

The heat resistance of the electric insulation cable was evaluated by performing the tensile test of the sheath after applying heat treatment to the electric insulation cable for 3000 hours at 150° C.

### (Oxidation Inducing Period)

In this example, in order to evaluate thermal stability of the electric insulation cable, the oxidation inducing period of the sheath was measured. As the oxidation inducing period of the sheath, the sheath was exposed to a specific temperature environment, and a length of the time required for generating heat by the sheath was measured. Specifically, 5 mg of sample was collected from the sheath of the electric insulation cable, and this sample was exposed under an environment of 230° C. by a differential scanning calorimeter, and the time required for generating heat was measured. In this example, when a heat generating reaction was started after elapse of 100 minutes or more, this case was regarded as success, and when the heat generating reaction was started from the earlier time, this case was regarded as failure.

### (Flame Retardancy)

The flame retardancy was based on ISO6722, and when self-extinguishing was performed within 70 seconds, this case was regarded as success, and when a combustion was continued exceeding 70 seconds, this case was regarded as failure.

### (5) Evaluation Result

The result of the above-mentioned evaluation was shown in the following table 3.

TABLE 3

| | | | Example | | | | | | Comparative example | | | | |
|---|---|---|---|---|---|---|---|---|---|---|---|---|---|
| | | | 1 | 2 | 3 | 4 | 5 | 6 | 1 | 2 | 3 | 4 | 5 |
| Structure | Sheath material | | A | A | C | E | F | G | H | H | I | B | D |
| of | Insulating layer material | | A | H | C | E | F | G | H | H | I | B | D |
| cable | Structure | | FIG. 2 | FIG. 1 | FIG. 2 | FIG. 2 | FIG. 2 | FIG. 2 | FIG. 3 | FIG. 2 | FIG. 2 | FIG. 2 | FIG. 2 |
| Evaluation | Adhesion | 0.5 | 0.4 | 0.1 | 0.4 | 0.4 | 0.5 | 0.4 | 0.1 | 10.3 | 0.5 | 0.4 | 0.5 |
| | Peeling strength | or less | | | | | | | | | | | |
| | (N/mm) | | | | | | | | | | | | |
| | Flexible | 35 | 50 | 36 | 44 | 42 | 58 | 42 | 15 | 40 | 41 | 50 | 43 |
| | slacking amount | or more | | | | | | | | | | | |
| | (mm) | | | | | | | | | | | | |
| | Heat-resistant | 50 | 70 | 75 | 180 | 120 | 65 | 125 | 50 | 50 | 50 | 45 | 180 |
| | elongation (%) | or more | | | | | | | | | | | |
| | Oxidation inducing | 100 | 105 | 106 | 340 | 180 | 110 | 183 | 81 | 78 | 88 | 98 | 344 |
| | period (minute) | or more | | | | | | | | | | | |
| | Flame retardancy | within | 27 | 27 | 62 | 31 | 60 | 22 | 36 | 30 | 34 | 29 | 72 |
| | (second) | 70 | | | | | | | | | | | |

As shown in table 3, in examples 1 to 6, any one of the evaluation items is regarded as success, and the electric insulation cable easy to perform a folding work of a metal braid and having excellent flexibility, flame retardancy, and thermal stability can be obtained. In examples 1, 3 to 6, since the inner layer separator is not provided in the electric insulation cable, more excellent flexibility is confirmed, than that of example 2 in which the inner layer separator is provided. In example 2, the insulating layer was crosslinked by organic peroxide, and the inner layer separator was required to be wound, and therefore it could be considered that tolerance of the flexibility was reduced. In example 4, there was a tolerance to the thermal stability and flame retardancy. In example 5, flexibility was excellent because the contents of the antioxidant and the flame retardant agent were more reduced than those of other examples, and therefore more excellent flexibility was confirmed. In example 6, the flame retardancy was more improved than that of example 4, by adding the aromatic azo-compound.

In comparative example 1, crosslinking is applied to the sheath and the insulating layer by organic peroxide, and as a result of providing the inner layer separator, the middle separator, and the outer layer separator, it was found that the flexibility was greatly deteriorated. In comparative example 2, as a result of removing the separator from comparative example 1, the insulating layer was excessively adhered to the braided shield, and therefore it was confirmed that the adhesion was failure. Further, in comparative examples 1 to 3, by crosslinking by organic peroxide or electron beam irradiation, the antioxidant was consumed during the crosslinking process, and it was confirmed that the oxidation inducing period was short and the thermal stability was deteriorated. In comparative example 4, due to less amount of the antioxidant than a regulated amount, the thermal stability and the oxidation inducing period were failure. In comparative example 5, due to more antioxidant than the regulated amount, the flame retardancy was failure.

### (Exemplary Aspects of the Present Invention)

Exemplary aspects of the present invention will be supplementarily described hereafter.

According to an aspect of the present invention, there is provided an electric insulation cable with shield, including:

conductors;

an insulating layer provided on an outer periphery of the conductors;

a braided shield provided on an outer periphery of the insulating layer; and

a sheath provided on an outer periphery of the braided shield,

wherein the sheath is made of a silane-crosslinked composition which is obtained by silane-crosslinking a non-halogen composition under a normal pressure, and the non-halogen composition includes 100 pts.mass of silane-grafted polymer obtained by graft copolymerizing a silane compound to the polymer including at least one of non-halogen rubber and ethylene-based copolymer, and pts.mass or more and 10 pts.mass or less of an antioxidant.

Preferably, the non-halogen composition includes 1 pts.mass or more and 7.5 pts.mass or less of the antioxidant.

Further exemplarily, the antioxidant includes a hindered phenol compound and a thioether compound.

Further preferably, a ratio of the hindered phenol compound to the thioether compound is 1 or more and 6 or less.

Further exemplarily, the non-halogen composition further includes a flame retardant agent, and includes 10 pts.mass or more and 150 pts.mass or less of the flame retardant agent with respect to 100 pts.mass of the silane-grafted polymer.

Further exemplarily, the sheath is provided immediately on the shield.

Further exemplarily, the insulating layer is made of the silane-crosslinked composition, and is provided immediately on the conductors.

Further exemplarily, the oxidation inducing period of the silane-crosslinked composition at 230° C. is 100 minutes or more.

What is claimed is:

1. An electric insulation cable with shield, comprising:
conductors;
an insulating layer provided on an outer periphery of the conductors;
a braided shield provided on an outer periphery of the insulating layer; and
a sheath provided on an outer periphery of the braided shield,
wherein the sheath is made of a silane-crosslinked composition which is obtained by silane-crosslinking a non-halogen composition under a normal pressure, and the non-halogen composition contains 100 pts.mass of silane-grafted polymer obtained by graft copolymerizing a silane compound to the polymer including at least one of non-halogen rubber and ethylene-based copolymer, and includes 1 pts.mass or more and 10 pts.mass or less of an antioxidant.

2. The electric insulation cable with shield according to claim 1, wherein the non-halogen composition includes 1 pts.mass or more and 7.5 pts.mass or less of the antioxidant.

3. The electric insulation cable with shield according to claim 1, wherein the antioxidant includes a hindered phenol compound and a thioether compound.

4. The electric insulation cable with shield according to claim 3, wherein a ratio of the hindered phenol compound to the thioether compound is 1 or more and 6 or less.

5. The electric insulation cable with shield according to claim 1, wherein the non-halogen composition further includes a flame retardant agent, and contains 10 pts.mass or more and 150 pts.mass or less of the flame retardant agent with respect to 100 pts.mass of the silane-grafted polymer.

6. The electric insulation cable with shield according to claim 1, wherein the sheath is provided immediately on the shield.

7. The electric insulation cable with shield according to claim 1, wherein the insulating layer is made of the silane-crosslinked composition, and is provided immediately on the conductors.

8. The electric insulation cable with shield according to claim 1, wherein the oxidation inducing period of the silane-crosslinked composition at 230° C. is 100 minutes or more.
